(19) United States
(12) Patent Application Publication
(10) Pub. No.: US 2020/0065915 A1
(43) Pub. Date: Feb. 27, 2020

(54) SOCIAL NETWORK PROFILE BASED ONLINE COMMUNITY MEMBER MANAGEMENT

(71) Applicant: International Business Machines Corporation, Armonk, NY (US)

(72) Inventors: Trudy L. Hewitt, Cary, NC (US); Shadi Albouyeh, Raleigh, NC (US); Jeremy R. Fox, Georgetown, TX (US)

(73) Assignee: International Business Machines Corporation, Armonk, NY (US)

(21) Appl. No.: 16/109,715

(22) Filed: Aug. 22, 2018

(51) Int. Cl. G06Q 50/00; G06N 7/00

(52) U.S. Cl. CPC G06Q 50/01; G06N 7/005

(57) ABSTRACT

From monitored content posted on an online community platform, a contextual baseline model is constructed for a user, the contextual baseline model representing interactions of the user with communities on the online community platform. Using a processor and a memory, a community addition for the user is detected. An inconsistency measure for the community addition relative to the contextual baseline model is computed. Responsive to determining that the inconsistency measure is above an inconsistency threshold, a probability that the user would prefer to be removed from the community is computed. Upon the probability exceeding a probability threshold, the user is removed from the community.

### TECHNICAL FIELD

The present invention relates generally to a method, system, and computer program product for managing participation in online communities. More particularly, the present invention relates to a method, system, and computer program product for social network profile based online community member management.

### BACKGROUND

People often interact through online communities. Such communities, like other social networking modalities, allow users to communicate and collaborate with each other. Online community platforms are typically divided into communities, each focused on a particular topic. Communities may also focus on subtopics and sub-subtopics as well, as traffic in a community becomes overwhelming and needs to be refined.

An “online community platform”, as used herein, refers to any social media or collaboration application, platform, website, or other software-based tool that allows users to join or leave groups or other subdivisions of content managed by the online community platform. Such groups, referred to as “communities” herein, allow users of such a platform to interact on specific topics, without forcing users to search through all content on a platform to find content that matches their interests.

Typically, once users join a community, all users see all content posted in that community, and are able to post content for other users to see and respond to. Users may view content on a website or via an application. Many online community platforms also offer other options for viewing content, such as emailing users each piece of content as it is posted, or grouping content into a digest—for example, on an hourly, daily, or weekly basis—and emailing the digest.

### SUMMARY

The illustrative embodiments provide a method, system, and computer program product. An embodiment includes a method that constructs, from monitored content posted on an online community platform, a contextual baseline model for a user, the contextual baseline model representing interactions of the user with communities on the online community platform. The embodiment detects, using a processor and a memory, a community addition for the user. The embodiment computes an inconsistency measure for the community addition relative to the contextual baseline model. The embodiment computes, responsive to determining that the inconsistency measure is above an inconsistency threshold, a probability that the user would prefer to be removed from the community. The embodiment removes, upon the probability exceeding a probability threshold, the user from the community.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for social network profile based online community member management in accordance with an illustrative embodiment; and

FIG. 4 depicts a flowchart of an example process for social network profile based online community member management in accordance with an illustrative embodiment.

### DETAILED DESCRIPTION

Users can join communities that suit their interests, and leave once those communities no longer suit their interests. Communities are often focused on particular topics, or aimed at particular types of users—but users' interests or characteristics may change over time. Hence users often remain members of communities that no longer suit their needs.

In addition, many online community platforms allow third parties to add users to communities. For example, consider an online community platform used as a workplace collaboration tool that, when a user first starts work, automatically adds the user to communities focused on the workplace site, everyone who works for the user's manager, the user's current project, and the user's broader research interests. Later, when the user changes projects, managers, or sites, the platform automatically adds the user to communities focused on the new project, manager, or site, but does not necessarily remove the user from previous communities. Designers of such platforms are often reluctant to remove users from communities they have been a part of, as such platforms are meant to foster connection.

On such platforms, third parties can also manually add users to communities. For example, a project manager staffing a new project may want to add all the members of her new team to a community focused on the project.

As a result, users are often added to communities without prior knowledge of the purpose of the community and how it relates to their particular role or interests. In addition, such platforms, designed to improve communication and collaboration, do not ask users to consent when a third party adds them to a community. As a result, users only have the option to leave a community after being added.

Thus, users often find themselves members of communities in which they are no longer interested, or in which they may not have been interested ab initio. In addition, leaving a community is often difficult—instructions for doing so may be obscure, require information users no longer have access to, or must be done one community at a time. This is a burden when users are members of a large number of communities.

The illustrative embodiments recognize that the presently available tools or solutions do not address these needs or provide adequate solutions for these needs. The illustrative embodiments used to describe the invention generally address and solve the above-described problems and other problems related to social network profile based online community member management.

An embodiment can be implemented as a software application. The application implementing an embodiment can be configured as a modification of an existing online community platform system, as a separate application that operates in conjunction with an existing online community platform system, a standalone application, or some combination thereof.

Particularly, some illustrative embodiments provide a method by which it can be determined whether a user has been added to a community that the user would not want to be added to, and if so, remedies the situation.

An embodiment can be configured to assist with all, or a subset of content hosted on an online community platform, all or some of the content hosted on one or more social networks, or all or some of the content a user interacts with on all platforms. An embodiment can be configured to assist with a particular type of content. For example, an embodiment might consider only video content, or only text content, to be within scope.

An embodiment can be configured to assist with content relating to a topic or area of interest. For example, an Austin-based user using a workplace collaboration platform finds content from other Austin-based users essential, but finds content from other users based elsewhere optional. This user could choose to select all non-Austin-based content as within scope. Another user using the same platform might view all work-related topics as essential, and non-work topics such as sports or hobbies as non-essential. This user could choose to select all non-work content as within scope.

In an embodiment, administrators of the platform can make such scope selections based on types of user. For example, the platform could be set up such that non-Austin content is within scope for all Austin-based users, or that all non-work content is within scope.

In an embodiment, users can make their own selections. For example, a childless user might choose to have all child-related content within scope.

An embodiment includes a default scope selection, for use when neither an administrator nor a user makes a scope selection. In addition, both users and administrators can change scope selections. For example, a user might change worksites, projects, or hobbies, and update the scope selections as appropriate for the new situation.

An embodiment monitors content within the selected scope. Using passive monitoring, an embodiment examines all or a subset of accessible content within the scope, either as the content arrives at the embodiment or at a later time. Using active monitoring, an embodiment is triggered to monitor using specific community based entry and exit criteria.

An embodiment identifies common traits, behaviors, or interests within the groups a user belongs to. The embodiment monitors content to determine if a user no longer has traits, behaviors, or interests in common with those groups. For example, using demographic information, an embodiment can determine that a user is a member of a group focused on toddlers, but the user's child is now older and toddler-focused content no longer applies. As another example, an embodiment can determine that a user used to spend a lot of time reading football blogs and watching, but not lately—as a sign that the user's interests may have changed.

An embodiment constructs a contextual baseline model for a user, based on the user's interactions with the monitored content and a determination that the user's traits, behaviors or interests no longer match that of a group. In particular, the model represents a user's context among groups he or she interacts with. The embodiment constructs the model using any suitable natural language understanding technique.

As an embodiment continues to monitor content over time, it continues to refine the model based on the activities being monitored. A user's interests and resulting activities may shift over time, and continued monitoring and refinement keeps the model representative of communities a user is likely to be interested in now rather than at some time in the past.

A user may add him or herself to a community; a third party, such as another user, an administrator, or the community platform acting automatically, can also add a user to a community. Adding a user to a community triggers an embodiment to assess the addition event against the contextual baseline model. In particular, an embodiment determines how consistent the addition is with the user's other communities. If the addition is very consistent with the user's other interests—for example, a user who is already a member of communities devoted to road biking, trail running, and hiking is added to a community focused on mountain biking—the user is likely to welcome this addition and the embodiment need do nothing more. However, if the addition is less consistent with the user's other interests—for example, a user who is already a member of communities devoted to road biking, trail running, and hiking is added to a community focused on crossword puzzles—the user may be less likely to welcome this addition. Thus, an embodiment considers an addition that is sufficiently outside what is normal for a user, as represented by the contextual baseline model—for example, a standard deviation outside—to be a triggering event. Other distance measures and determinations of a triggering event are also possible and contemplated within the scope of the illustrative embodiments.

An embodiment infers the focus of the community being added, using the name of the community, metadata associated with the community, the demographics of the user and the community, the known interests of other members of the community, and other data. Using such data helps resolve ambiguities. For example, a community might be named “people who love the stars”. Based on the name alone, such a community might be focused on astronomy or the Dallas Cowboys football team (which uses a star as its emblem). However, if other members of the community are also members of other astronomy-focused communities, this community is much more likely to be astronomy-focused, not Cowboys-focused. An embodiment makes such inferences using artificial intelligence techniques, for example, or any other suitable techniques.

Once an embodiment has determined that a triggering event has occurred, the embodiment assesses a likelihood that a user would prefer to be removed from the community he or she has just been added to. In making this assessment, an embodiment takes into account several factors. One factor is associated with the requester of the addition. If a user requested addition to a community, that user is more likely to want that addition, even if the community is outside the user's other interests. For example, the user might be taking up a new hobby or be newly assigned to a work project in a different subject area. Conversely, if a third party made the request and the new community is outside the user's norm, the user is less likely to want the addition.

Another factor assesses the likelihood that the user does not want to be added to the community. For example, if a user is already a member of communities devoted to road biking, trail running, and hiking, but has never interacted with any community focused on any type of indoor hobby, it would be logical for an embodiment to conclude that the user, if added to a community focused on crossword puzzles, might not be interested in that community. Instead, someone else might have added the user to that community, perhaps as a joke.

Another factor assesses the likelihood that the community addition is not authorized. For example, consider a community is only for employees of a specific company. If a third party adds a non-employee user to the group, this addition is not authorized, even if the user's interests match the group's.

Another factor assesses the likelihood that the community addition is misplaced in time—either early or late. For example, if a user is active in several communities focused on parenting very young children, it would be logical for an embodiment to conclude that the user might not be interested in a community focused on parenting teenagers. However, as time passes, and the user is no longer active in communities focused on parenting very young children, the user might be more interested in a community focused on parenting teenagers because her own children have now become teenagers.

The factors described herein are only examples of possible criteria. In assessing a likelihood that a user would prefer to be removed from the community he or she has just been added to, an embodiment may use any suitable technique, including criteria specified by a user or administrator of the platform.

When an embodiment determines that the likelihood that a user would prefer to be removed from the community he or she has just been added to is above a threshold, the embodiment provides the user with the option to accept the embodiment's decision and leave the community, or reject the embodiment's decision and remain in the community. Alternatively, an embodiment implements user profile settings that always accept the embodiment's decision without giving the user an opportunity to override, or to accept the embodiment's decision under certain circumstances and query the user under other circumstances. For example, a user could choose not to receive an override opportunity when another user has added the first user to a community, but could choose to receive an override opportunity when an administrator has added the first user to a community.

An embodiment also evaluates community additions for a group of users in the same manner as an evaluation for a single user. Such group-based evaluations are useful in situations when groups of users are automatically added to communities. For example, a workplace collaboration tool may automatically add groups of users to communities based on users' worksites, managers, divisions, projects, or job functions. However, such standardized, group-based additions have the potential to be over-inclusive, adding too many users to unwanted communities. For example, a group of assembly language programmers may be automatically added to a work-based community focusing on general programming, but the general programming content present in the community is unlikely to interest specialized assembly language programmers.

An embodiment predicts a user's response to the question of whether to leave the community just added. An embodiment uses differences between the prediction and the user's actual response to further refine the contextual baseline model and the embodiment's determination of the likelihood that a user would prefer to be removed from a community.

The manner of social network profile based online community member management described herein is unavailable in the presently available methods. A method of an embodiment described herein, when implemented to execute on a device or data processing system, comprises substantial advancement of the functionality of that device or data processing system in determining that a user would not want to remain in a community he or she has been added to.

The illustrative embodiments are described with respect to certain types of contents, social network platforms, social network communities, transmissions, delays, events, periods, forecasts, thresholds, validations, responses, rankings, adjustments, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

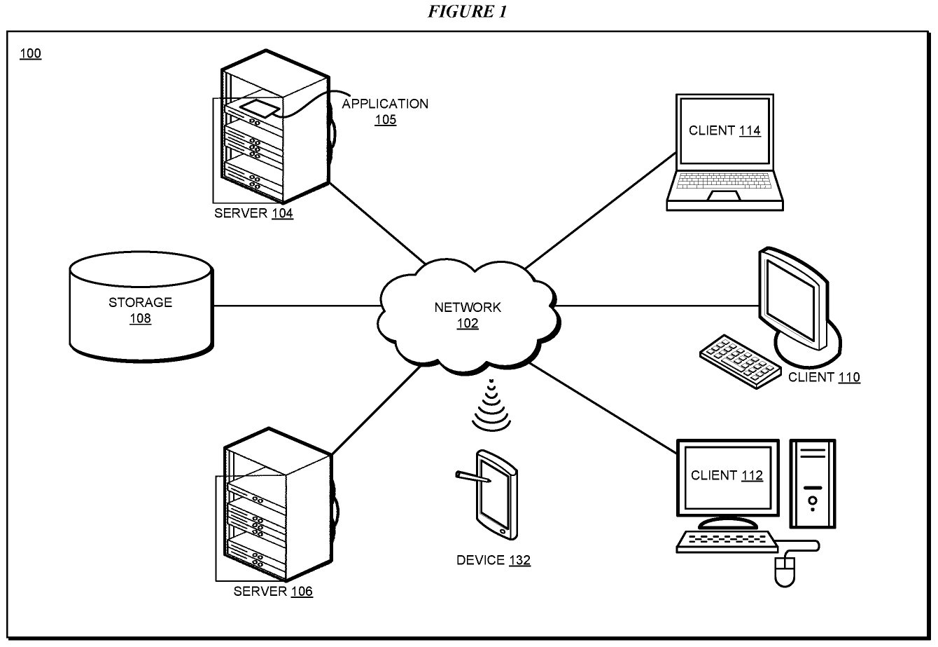

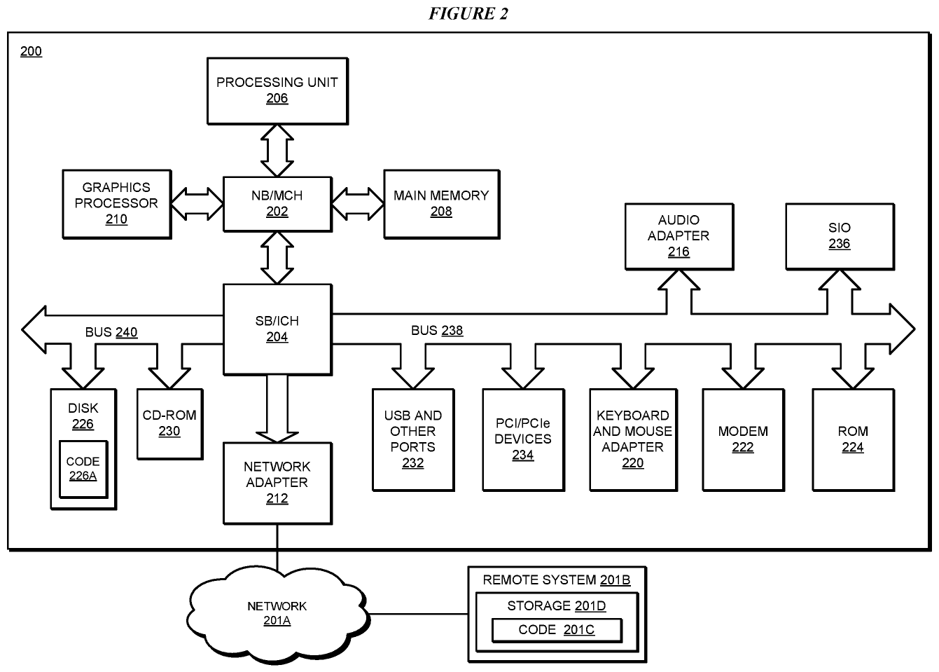

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Application 105 may run in server 104 or on any other suitable platform. A user may interact with application 105 using clients 110, 112, or 114, or device 132.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

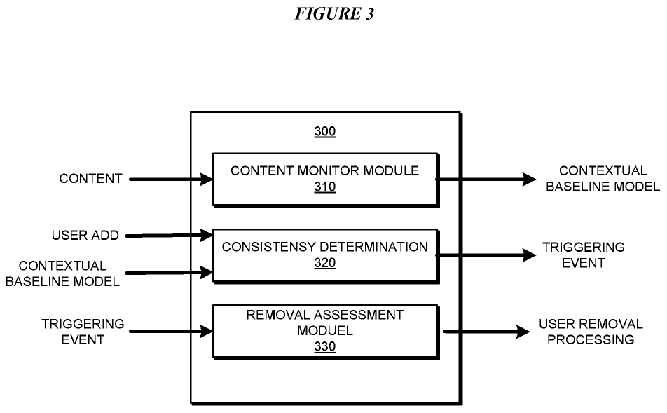

With reference to FIG. 3, this figure depicts a block diagram of an example configuration for social network profile based online community member management in accordance with an illustrative embodiment. Platform application 300 is an example of application 105 in FIG. 1 and executes in server 104 in FIG. 1.

Content monitor module 310 monitors content posted on a community platform managed by platform application 300. Content monitor module 310 employs both active and passive monitoring. Using passive monitoring, module 310 examines all or a subset of accessible content within a defined monitoring scope, either as the content arrives at the embodiment or at a later time. Using active monitoring, an embodiment is triggered to monitor using specific community based entry and exit criteria.

Based on the monitored content, content monitor module 310 constructs a contextual baseline model for a user using natural language understanding techniques.

When a user is added to a community managed by platform application 300, consistency determination module 320, referencing the contextual baseline model, determines whether the user addition is sufficiently outside what is “normal” for a user to be considered a triggering event. Once a triggering event has occurred, removal assessment module 330 assesses a likelihood that a user would prefer to be removed from the community he or she has just been added to. If module 330 determines that the likelihood that a user would prefer to be removed from the community he or she has just been added to is above a threshold, application 300 proceeds to process the user removal. Depending on the configuration of application 300, either the user is asked whether he or she wants to leave the community, or application processes the user's removal without consulting the user.

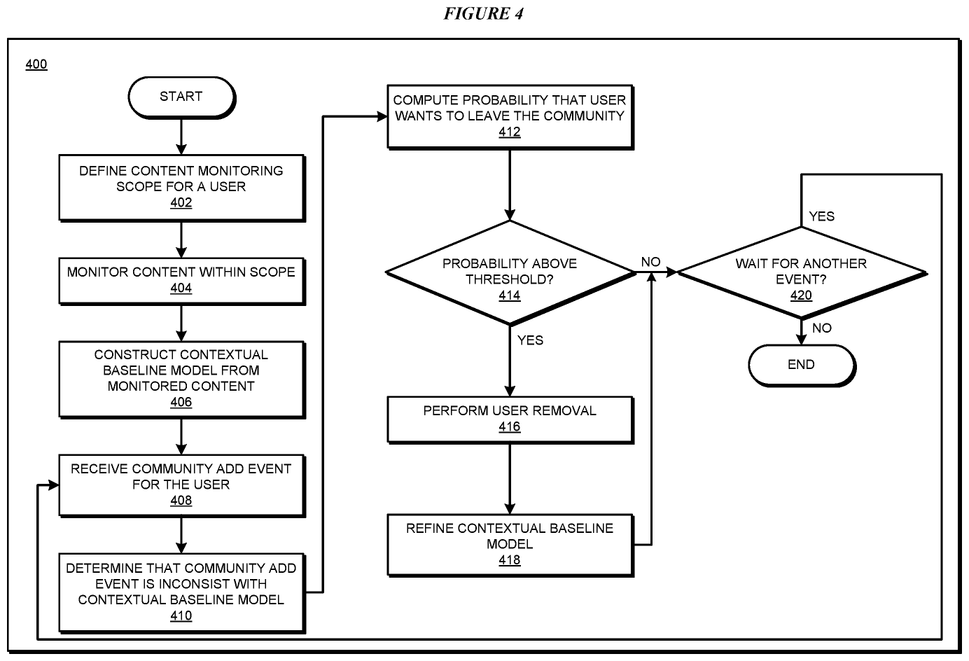

With reference to FIG. 4, this figure depicts a flowchart of an example process for social network profile based online community member management in accordance with an illustrative embodiment. Application 400 is the same as application 300 in FIG. 3.

In block 402, application 400 configures the scope of community content to be subject to the application's assistance. Application 400 can be set to monitor all, or a subset of content hosted on the platform managed by application 400. A content subset can be selected by content type (such as text or video) or a content topic (e.g. not work-related). Individual users and platform administrators can configure application 400 to assist with a particular scope of content. Application 400 also includes a default scope for use when neither an administrator nor a user makes a scope selection.

In block 404, application 400 monitors content within the selected scope. In block 406, application 400 constructs a contextual baseline model for a user, based on the user's interactions with the monitored content. In block 408, application 400 receives a community addition event for the user. Either the user or a third party may have added the user to a community managed using application 400. In block 410, application 400 determines that the community addition event is inconsistent with the contextual baseline model for the user. In block 412, application 400 computes a probability that the user would prefer to be removed from the community. In block 414, application 400 determines whether or not the probability is above a threshold. If yes, in block 416, application 400 performs a user removal process, and in block 418, application 400 refines the contextual baseline model based on the outcome of the user removal process. Application 400 continues in block 420, where application 400 determines whether or not to wait for another community add event. If yes, application 400 returns to block 408; if not, the process ends.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
constructing, from monitored content posted on an online community platform, a contextual baseline model for a user, the contextual baseline model representing interactions of the user with communities on the online community platform;
detecting, using a processor and a memory, a community addition for the user;
computing an inconsistency measure for the community addition relative to the contextual baseline model;
computing, responsive to determining that the inconsistency measure is above an inconsistency threshold, a probability that the user would prefer to be removed from the community; and
removing, upon the probability exceeding a probability threshold, the user from the community.

2. The method of claim 1, further comprising:
defining a scope of monitoring for content posted on an online community platform;
monitoring content posted on an online community platform within the scope of monitoring.

3. The method of claim 1, wherein computing a probability that the user would prefer to be removed from the community further comprises:
determining a factor associated with a requester of the community addition;
determining a first likelihood that the user does not desire the community addition;
determining a second likelihood that the community addition is associated with a time period different by more than a threshold different from a current time period; and
computing the probability based on the factor, the first likelihood, and the second likelihood.

4. The method of claim 1, wherein removing the user from the community further comprises:
receiving a response from the user as to whether removal from the community is desired;
removing, in response to a positive response from the user, the user from the community.

5. The method of claim 4, further comprising:
updating, in response to a positive response from the user, the contextual baseline model for the user.

6. A computer usable program product comprising one or more computer-readable storage devices, and program instructions stored on at least one of the one or more storage devices, the stored program instructions comprising:
program instructions to construct, from monitored content posted on an online community platform, a contextual baseline model for a user, the contextual baseline model representing interactions of the user with communities on the online community platform;
program instructions to detect, using a processor and a memory, a community addition for the user;
program instructions to compute an inconsistency measure for the community addition relative to the contextual baseline model;
program instructions to compute, responsive to determining that the inconsistency measure is above an inconsistency threshold, a probability that the user would prefer to be removed from the community; and
program instructions to remove, upon the probability exceeding a probability threshold, the user from the community.

7. The computer usable program product of claim 6, further comprising:
program instructions to define a scope of monitoring for content posted on an online community platform; and
program instructions to monitor content posted on an online community platform within the scope of monitoring.

8. The computer usable program product of claim 6, wherein computing a probability that the user would prefer to be removed from the community further comprises:
program instructions to determine a factor associated with a requester of the community addition;
program instructions to determine a first likelihood that the user does not desire the community addition;
program instructions to determine a second likelihood the community addition is associated with a time period different by more than a threshold different from a current time period; and
program instructions to compute the probability based on the factor, the first likelihood, and the second likelihood.

9. The computer usable program product of claim 6, wherein removing the user from the community further comprises:
program instructions to receive a response from the user as to whether removal from the community is desired;
program instructions to remove, in response to a positive response from the user, the user from the community.

10. The computer usable program product of claim 6, further comprising:
program instructions to update, in response to a positive response from the user, the contextual baseline model for the user.

11. The computer usable program product of claim 6, wherein the computer usable code is stored in a computer readable storage device in a data processing system, and wherein the computer usable code is transferred over a network from a remote data processing system.

12. The computer usable program product of claim 6, wherein the computer usable code is stored in a computer readable storage device in a server data processing system, and wherein the computer usable code is downloaded over a network to a remote data processing system for use in a computer readable storage device associated with the remote data processing system.

13. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to construct, from monitored content posted on an online community platform, a contextual baseline model for a user, the contextual baseline model representing interactions of the user with communities on the online community platform;
program instructions to detect, using a processor and a memory, a community addition for the user;
program instructions to compute an inconsistency measure for the community addition relative to the contextual baseline model;
program instructions to compute, responsive to determining that the inconsistency measure is above an inconsistency threshold, a probability that the user would prefer to be removed from the community; and
program instructions to remove, upon the probability exceeding a probability threshold, the user from the community.

14. The computer system of claim 13, further comprising:
program instructions to define a scope of monitoring for content posted on an online community platform; and
program instructions to monitor content posted on an online community platform within the scope of monitoring.

15. The computer system of claim 13, wherein computing a probability that the user would prefer to be removed from the community further comprises:
program instructions to determine a factor associated with a requester of the community addition;
program instructions to determine a first likelihood that the user does not desire the community addition;
program instructions to determine a second likelihood the community addition is associated with a time period different by more than a threshold different from a current time period; and
program instructions to compute the probability based on the factor, the first likelihood, and the second likelihood.

16. The computer system of claim 13, wherein removing the user from the community further comprises:
program instructions to receive a response from the user as to whether removal from the community is desired;
program instructions to remove, in response to a positive response from the user, the user from the community.

17. The computer system of claim 13, further comprising:
program instructions to update, in response to a positive response from the user, the contextual baseline model for the user.

18. The computer system of claim 13, wherein the computer usable code is stored in a computer readable storage device in a data processing system, and wherein the computer usable code is transferred over a network from a remote data processing system.

19. The computer system of claim 13, wherein the computer usable code is stored in a computer readable storage device in a server data processing system, and wherein the computer usable code is downloaded over a network to a remote data processing system for use in a computer readable storage device associated with the remote data processing system.
